(19) United States
(12) Patent Application Publication
(10) Pub. No.: US 2007/0294637 A1
(43) Pub. Date: Dec. 20, 2007

(54) GROUPED CASCADING USER INTERFACE

(76) Inventor: Martin Renaud, Maple Ridge (CA)

Correspondence Address: PERKINS COIE LLP;PATENT-SEA, P.O. BOX 1247, SEATTLE, WA, 98111-1247, US

(21) Appl. No.: 11/766,021

(22) Filed: Jun. 20, 2007

Related U.S. Application Data
(60) Provisional application No. 60/815,495, filed on Jun. 20, 2006.

(51) Int. Cl. G06F 3/048

(52) U.S. Cl. 715/814

(57) ABSTRACT

Systems and methods for displaying a graphical user interface are disclosed. In some embodiments, the method can include displaying a primary user-selectable control in a graphical user interface, receiving a user selection of the primary displayed control, displaying a first group of user-selectable controls based on the selected primary control, and, after expiration of a predetermined time, automatically displaying a second group of user-selectable controls based on the selected primary control.

### CROSS REFERENCE TO RELATED APPLICATIONS

This application claims priority to U.S. Provisional Patent Application Ser. No. 60/815,495, filed Jun. 20, 2006, entitled “Grouped Cascading User Interface,” the content of which is hereby incorporated by reference in its entirety.

This application is related to U.S. Patent Application Ser. No. 60/797,718, filed May 4, 2006, entitled “System And Method of Enhancing User Authentication Through Estimation of Future Response Patterns,” the content of which is hereby incorporated by reference in its entirety.

### BACKGROUND

Software designers are continuously adapting the user interfaces of their products to enhance the speed and ease of use of-their products for users. One of the main features of the user experience that is affected by these improvements is search. While search is most commonly associated with attempts by a user to find information on the Internet, search is essentially a broad concept that includes finding information on each web page or within specific sections of a web page. Users seek to use software tools that will facilitate fast, efficient search in all contexts.

Improvements in search have numerous effects on the user experience. One such effect is to increase the pleasantness of the user experience. Users who are pleased with the usability of the system will be more likely to continue using that system. Another effect, somewhat related to the first, is that users will be able to conduct their business faster and more efficiently. A fast and pleasant user experience is the end goal for developers of search improvements.

Users of computer software often search the program interface for a specific control button to perform a certain task. The relevant control button may be located on a taskbar at the top or bottom of the page among a larger set of control buttons. For example, in many word processing applications, the taskbars for formatting controls, font controls, file access controls and numerous other types of task controls are all located together at the top of the screen, such that identifying any given control can be difficult.

For example, the Apple OS X presents a list of application controls in its “Dock” at the bottom of the screen. The Dock has a useful advantage over some Windows-based word processor presentation styles in that it appears only when the mouse cursor is positioned at the Dock location. As a result, the Dock does not clutter the display when it is not needed. However, even with a Dock taskbar, the user still is required to visually search through the Dock to find the desired control. This search process requires time and often can be frustrating for the user.

A similar problem arises in Internet search engines. Google, arguably the most popular search engine, has created a simple text interface that lists little more than the titles of the pages that match a search query. In addition, the presentation window limits the number of titles to (usually) 10 items. The user must still visually search from one item to another in the list before deciding if the list contains a relevant result or not. The uniform presentation style results in all of the items having a similar perceptual salience for the user. Effectively, nothing stands out as more or less relevant than the others, until the user reads through the list.

Searching could be drastically improved if the items of interest were presented so that the user's natural, mental search processes could interact with the presentation format to reduce search time and increase usability and effectiveness. The user would benefit from a presentation mechanism that would allow the user to perform a preliminary scan of the information, without actually reading through it all, facilitating rapid identification of the material the user wants to see.

Such a system could also enhance the effectiveness of digital security systems that rely on human recognition processes for their effectiveness. The effectiveness of digital security systems is often a tradeoff between usability and security. For example, CAPTCHAs are random strings of letters and numbers displayed in an image file. CAPTCHAs are designed to prevent the use of “Optical Character Recognition” (OCR) by Trojan horse code or various other forms of malware. The use of distorted characters in an image file is challenging for humans to read quickly, but almost impossible for computers to decipher. The continuous evolution of that technology has been driven by the tradeoffs between human recognition limitations and computer image parsing for recognizable characters.

Other known systems have a user enroll an event from his own life (a nostalgic experience) using a unique set of recognition responses that match his own life experience. During authentication, the user simply replays his recognition responses. Although the authentication experience is fairly quick, users may still experience annoyance at conducting a series of search tasks simultaneously. The feeling of annoyance may contribute to a lack of involvement in the task, and lower the expected performance accuracy and thereby compromise security.

As the discussion above suggests, there is a need for enhanced techniques to facilitate search of an interface. The systems and methods described below facilitate searching an interface and thereby enhance its effectiveness and speed, rendering the user experience within the interface as more pleasant and useful.

### BRIEF DESCRIPTION OF THE DRAWINGS

FIG. 1 is a block diagram illustrating a suitable computer for practicing the disclosed interface.

FIG. 2 is a block diagram illustrating a suitable system in which various embodiments may operate in a networked computer environment.

FIGS. 3A-3C illustrate exemplary groups of controls.

FIG. 4 illustrates a process flow for an exemplary embodiment.

FIG. 5A illustrates an exemplary set of controls and FIG. 5B illustrates groups of cascaded controls.

FIGS. 6A and 6B illustrate exemplary layouts for groups of cascaded controls.

FIGS. 7, 8 and 9 illustrate an example implementation of an alternative security interface.

### DETAILED DESCRIPTION

The following description provides specific details for a thorough understanding and enabling description of various embodiments. The embodiments described herein may be practiced without many of these details. Additionally, some well-known structures or functions may not be shown or described in detail, so as to avoid unnecessarily obscuring the relevant description of the various embodiments.

The terminology used in the description presented below is intended to be interpreted in its broadest reasonable manner, even though it is being used in conjunction with a detailed description of certain specific embodiments. While certain terms may be emphasized below, any terminology intended to be interpreted in any restricted manner will be explicitly and specifically defined as such.

### I. REPRESENTATIVE COMPUTING ENVIRONMENT

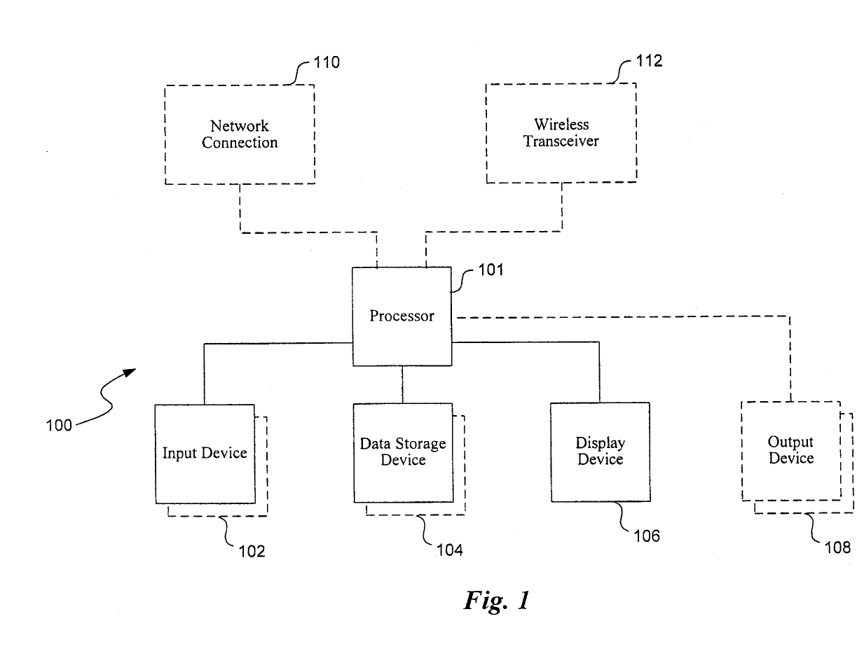

FIG. 1 and the following discussion provide a brief, general description of a suitable computing environment in which various embodiments of the disclosed interface can be implemented. Although not required, aspects and embodiments will be described in the general context of computer-executable instructions, such as routines executed by a general-purpose computer, e.g., a server or personal computer. The embodiments described herein can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like. The embodiments can be embodied in a special purpose computer or data processor that is specifically programmed, configured or constructed to perform one or more of the computer-executable instructions explained in detail below. The term “computer”, as used generally herein, refers to any of the above devices, as well as any data processor.

The embodiments can also be practiced in distributed computing environments, where tasks or modules are performed by remote processing devices, which are linked through a communications network, such as a Local Area Network (“LAN”), Wide Area Network (“WAN”) or the Internet. In a distributed computing environment, program modules or sub-routines, may be located in both local and remote memory storage devices. Aspects of the interface described below may be stored or distributed on computer-readable media, including magnetic and optically readable and removable computer discs, stored as firmware in chips (e.g., EEPROM chips), as well as distributed electronically over the Internet or over other networks (including wireless networks). Portions of the interface may reside on a server computer, while corresponding portions reside on a client computer. Data structures and transmission of data particular to aspects of the interface are also encompassed within the scope of the disclosure.

Referring to FIG. 1, one embodiment of the interface employs a computer 100, such as a personal computer or workstation, having one or more processors 101 coupled to one or more user input devices 102 and data storage devices 104. The computer is also coupled to at least one output device such as a display device 106 and one or more optional additional output devices 108 (e.g., printer, plotter, speakers, tactile or olfactory output devices, etc.). The computer may be coupled to external computers, such as via an optional network connection 110, a wireless transceiver 112, or both.

The input devices 102 may include a keyboard and/or a pointing device such as a mouse. Other input devices are possible such as a microphone, joystick, pen, game pad, scanner, digital camera, video camera, and the like. The data storage devices 104 may include any type of computer-readable media that can store data accessible by the computer 100, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network such as a local area network (LAN), wide area network (WAN) or the Internet (not shown in FIG. 1).

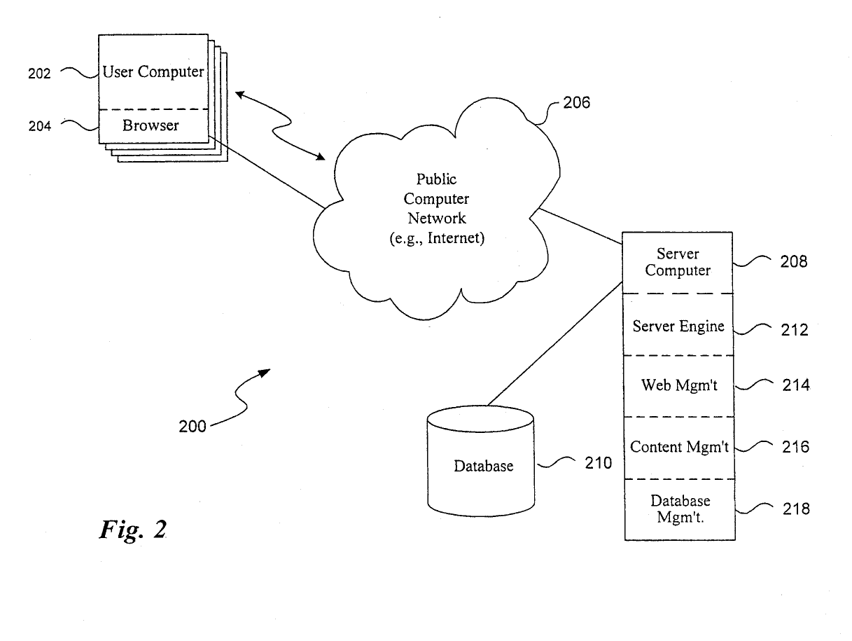

Aspects of the interface may be practiced in a variety of other computing environments. For example, referring to FIG. 2, a distributed computing environment with a web interface includes one or more user computers 202 in a system 200 are shown, each of which includes a browser program module 204 that permits the computer to access and exchange data with the Internet 206, including web sites within the World Wide Web portion of the Internet. The user computers may be substantially similar to the computer described above with respect to FIG. 1. User computers may include other program modules such as an operating system, one or more application programs (e.g., word processing or spread sheet applications), and the like. The computers may be general-purpose devices that can be programmed to run various types of applications, or they may be single-purpose devices optimized or limited to a particular function or class of functions. Any application program for providing a graphical user interface to a user may be employed. An exemplary web browser and web interface are described in more detail below.

At least one server computer 208, coupled to the Internet or World Wide Web (“Web”) 206, performs functions including receiving, routing and storing of electronic messages, such as web pages, audio signals, and electronic images. While the Internet is shown, a private network, such as an intranet may indeed be preferred in some applications. The network may have a client-server architecture, in which a computer is dedicated to serving other client computers, or it may have other architectures such as a peer-to-peer, in which one or more computers serve simultaneously as servers and clients. A database 210 or databases, coupled to the server computer(s), stores much of the web pages and content exchanged between the user computers. The server computer(s), including the database(s), may employ security measures to inhibit malicious attacks on the system, and to preserve integrity of the messages and data stored therein (e.g., firewall systems, secure socket layers (SSL), password protection schemes, encryption, and the like).

The server computer 208 may include a server engine 212, a web page management component 214, a content management component 216 and a database management component 218. The server engine performs basic processing and operating system level tasks. The web page management component handles creation and display or routing of web pages. Users may access the server computer by means of a URL associated therewith. The content management component handles most of the functions in the embodiments described herein. The database management component includes storage and retrieval tasks with respect to the database, queries to the database, and storage of data such as video, graphics and audio signals.

Aspects of the interface may be stored or distributed on computer-readable media, including magnetically or optically readable computer discs, hard-wired or preprogrammed chips (e.g., EEPROM semiconductor chips), nanotechnology memory, biological memory, or other data storage media. Computer implemented instructions, data structures, screen displays, and other data under aspects of the interface may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Portions of the interface reside on a server computer, while corresponding portions reside on a client computer such as a mobile or portable device, and thus, while certain hardware platforms are described herein, aspects of the interface are equally applicable to nodes on a network.

Further details on various embodiments of the interface are provided below.

### II. CONTROL SET GROUPING

The user interface described herein presents information in a cascade of manageable groups of controls, questions, or other information to be provided to a user. In doing so, the cascading interface takes advantage of a user's prior knowledge of what the user is searching for and the user's rapid rejection of small sets of controls that do not match the intended search target.

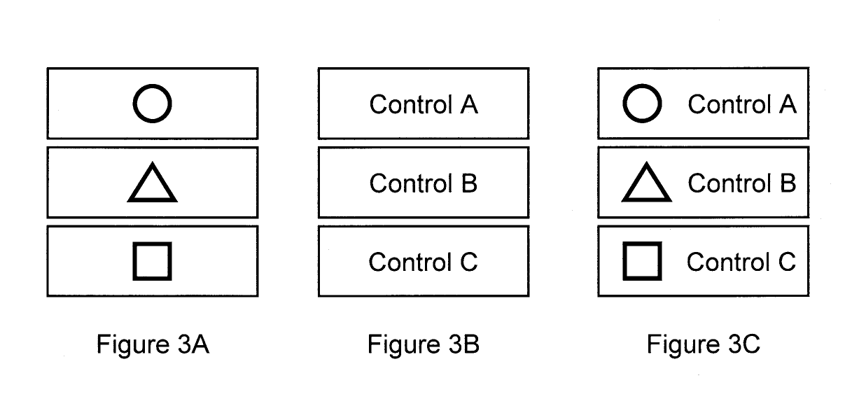

The controls described herein can include illustrated graphical icons with no readable text as shown in FIG. 3A, readable text with no illustrated component as shown in FIG. 3B, or a combination of both as shown in FIG. 3C. Other variations are possible and within the scope of the disclosure. Controls comprising a graphical or illustrated component may include what is commonly referred to in the art as a “button” or an “icon”. In the embodiments described below, the interface can be configured such that user selection of a control can cause the execution of any program instruction. Further, aspects of the interface are not limited to controls, but extend to other information to be displayed to a user, such as several multiple choice questions.

In some embodiments, the interface can be configured to limit the set size to a small number of controls from which the user can choose. For example, in one embodiment, controls could be displayed in sets of at most three controls so that the user does not encounter groups of more than three controls at a time. By limiting the set size during an interval, the user is better able to identify a desired control in a group, navigate to it, and select it. As a result, the user can more easily and comfortably interact with the interface.

In some further embodiments, the set size can be selected so that the user is able to capture all of the information contained in the set within a single visual fixation. The display of a small predetermined number of controls allows the user to know what to expect from the upcoming display change and to search efficiently, treating non-match controls as “distractors” to be ignored.

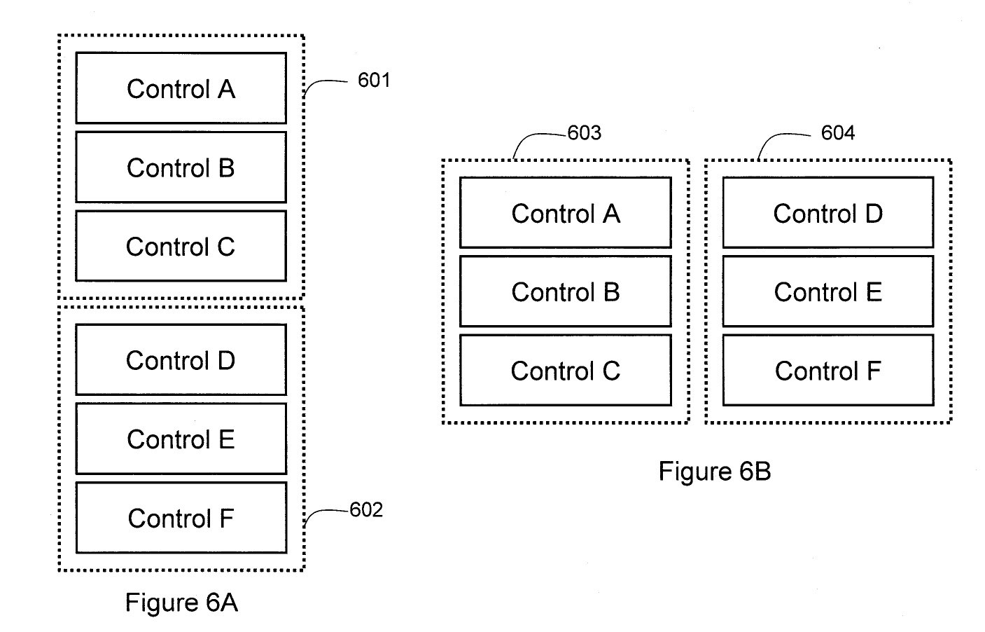

In some embodiments, the user's task of finding a particular control can be partially facilitated by a visual separation between different sets. As a non-limiting example, the size of the separation space can be as little as ⅓ to ½ the size of a single control within a group. The separation space can be similar in color and design to the overall background of the computer desktop on the user's device. Such a presentation can allow the user to quickly differentiate and identify the set that includes the intended search target from those sets that do not include the intended search target. An exemplary visual separation is illustrated between “Control C” in group 601 and “Control D” in group 602 in FIG. 6A.

### III. CASCADING CONTROLS

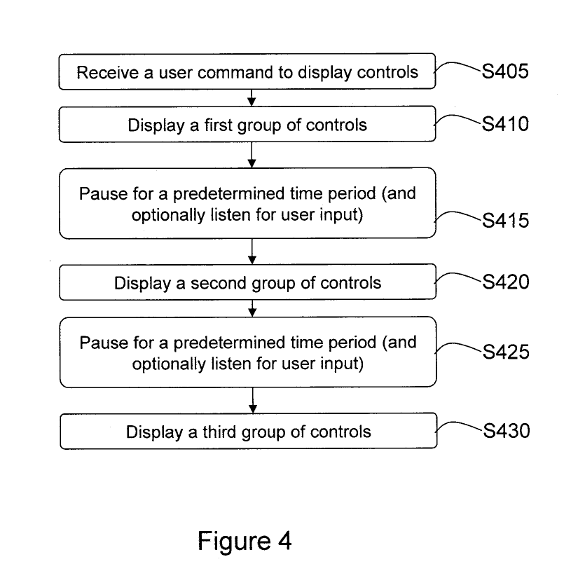

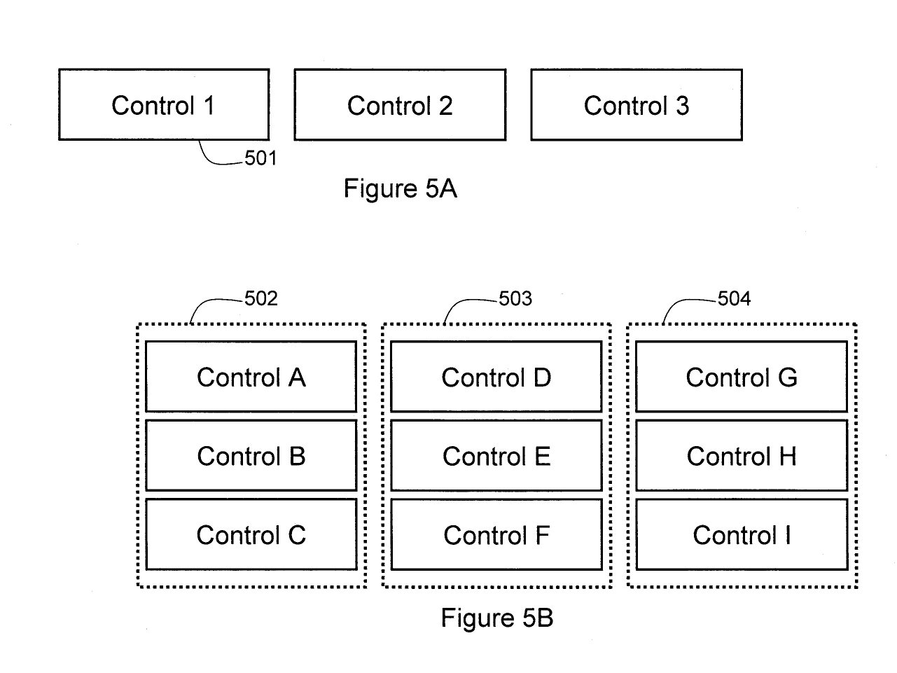

In some embodiments, groups of controls for selection can be cascaded. As a result of the cascading interface, groups of controls can be absent from the interface until needed. Further, a subsequently displayed group can be hierarchically related to the previous group. In some embodiments, the interface can present groups of controls in a cascade of presentations separated by a time delay or a visual spacer. With reference to FIG. 4, the graphical user interface can receive a command from a user to display one or more controls in step S405. For example, to locate a particular control, a user may access a primary control, such as a toolbar command, that contains the desired control. As illustrated in FIGS. 5A and 5B, a user can select “Control 1” 501 and thereby cause the cascade of grouped controls 502-504 to be displayed in step S410.

In some embodiments, the controls can be displayed at rate of one group each ¼ second. This time interval can vary depending upon targeted users, application employing the user interface, etc. In these embodiments, selection of “Control 1” 501 would cause the immediate display of Controls A-C from group 502. The interface can then pause for ¼ second after the display of group 502. During this pause time, the interface can listen for user input or response in step S415. As non-limiting examples, a user input can include a mouse click, mouse movement, or key press. After the expiration of the pause time, Controls D-F of group 503 can be displayed in step S420. Similarly, as shown by S425, the interface can then pause again for ¼ second and listen for a user input after the display of group 503 before displaying group 504 containing Controls G-I in step 430. Other delay periods are possible. In some embodiments, the interface may pause before presenting subsequent controls without waiting for additional user input.

The use of cascading groups focuses the user's attention on a specific part of the display so that the search target can be quickly differentiated from the background. The timing of the cascading can be based on the approximate length of a single saccade-fixation cycle. Approximately every quarter of a second, the human eye is able to capture a single glimpse of the visual field, taking approximately 30-50 milliseconds to acquire visual information (fixation time) and approximately 200 milliseconds to assimilate and reduce the incoming information (saccade time). If a desired control is shown, the user may identify it and begin a mouse movement in the direction of the control. If the desired control is not present in a particular group, the user will realize this and will decide to delay movement. As fixation jumps are not perceptible to humans, in some embodiments, the interface can be configured so that the delay between the display of subsequent cascaded groups is imperceptible. The user may thereby be able to locate the desired control without confusion and without the sensation of having conducted a search. Furthermore, the grouped cascade presentation format can enable the user to quickly and accurately dismiss non-target controls so he can direct his mouse toward the desired control.

In some embodiments, as a user watches the screen, several groups of controls can be displayed in sequence with a delay between groups. Display of cascaded groups of controls can be configured so that the display of subsequent groups occurs approximately 30-50 milliseconds after the display of the previous group. Thus, the display of cascaded groups of controls can be configured so that the display of subsequent groups occurs approximately 200 milliseconds after the display of the previous group.

A target that is perceived to be large is more rapidly found by users than one that is perceived to be small. In some embodiments, the size of the targets or controls displayed in a group can be selected so that a perceptually larger target is created. The grouping of targets and the separation between the groups can be selected so as to effectively increase the perceived target size for each of the individual components of the group. As a result, the individual controls will perceptually seem to be larger than one button by itself. The appearance of a larger target can lead to faster movements toward the target. For example, if each control is a square centimeter in area, the group of three has an area of 3 cm sq., and each individual item may be perceived has a target of 3 cm sq.

Groups of cascaded controls can appear in a vertical arrangement as shown in FIG. 6A or in groups arranged horizontally as shown in FIG. 6B. In the vertical arrangement illustrated in FIG. 6A, control group 601 will first be displayed, and, after a predetermined delay elapses, control group 602 will be displayed under group 601. As described above, a separation space may be displayed between the two groups. In other embodiments, groups 601 and 602 can be displayed so as to appear continuous without a separation space. In the horizontal arrangement illustrated in FIG. 6B, control group 603 will be displayed, and, after a predetermined delay elapses, control group 604 will be displayed along a side of group 603. Other graphical and geometric arrangements and relationships are possible without departing from the scope of this disclosure.

Cascaded groups of controls can be used in place of (or in addition to) the traditional display of task controls typically placed in the upper area of a program's user interface. The cascaded controls described herein could be used as a replacement for the traditional interface for any program with a linear (horizontal or vertical) list of controls. As a non-limiting example, the interface can be blank, except for a single small group of primary controls in the top left hand corner. An arrangement of controls such as the exemplary arrangement shown in FIG. 5A could be used in place of or in addition to a prior art task bar or tool bar.

Positioning the mouse over one of Controls 1-3 illustrated in FIG. 5A begins the first level of a cascade of hierarchical controls, where the control on which the mouse (or other cursor) rests begins the presentation of the appropriate groups of controls within the logical hierarchical sequence as described above. As a non-limiting example, in nearly any program, the interface could be modified by removing the static display of toolbars and associated drop-down menus and replacing them with three primary controls denoting file functions, editing functions and reference functions. As described above, this group of primary controls can be transformed by a single mouse click on the preferred function set which begins a cascade of groups of controls. An exemplary cascade is illustrated in FIG. 5B. The user can then click on the desired single control during the cascading process to end the cascade. While this disclosure describes one or more “clicks” to select a control, other mechanisms for selecting a control, such as a simple mouse-over, are possible and are within the scope of the disclosure.

In an alternative embodiment, the interface can be configured so that rejected groups can fade from view as other groups are displayed. This can reduce visual clutter and confusion caused by multiple controls occupying the interface. Removal of rejected groups can also be used to constrain the user to respond appropriately within a predetermined time. The combination of reduced clutter and predetermined time to respond can increase the search efficiency of the user and result in a better, faster and more intuitive user experience. Likewise, groups can fade into view, to reduce sudden visual changes.

In some embodiments, the interface can be configured so that cascaded controls are selected for display based on one or more monitored use-history variables. Given that each user has a propensity to use some controls more than others, the interface can be configured to monitor the history of the user within any application so that the controls used most often have the highest probability of being presented first. In some embodiments, the interface can be configured to reorder the presentation of control groups. For example, the groups illustrated in FIG. 5B could be displayed in the order of, from left to right, 503, 504, and then 502. Alternatively, or in addition, controls within groups could be reordered so that, for example, group 502 would display, from top to bottom, Control C, Control B, then Control A. Other arrangements are possible and within the scope of this disclosure.

In some embodiments, grouped cascading components could be used to replace prior art vertical pop-up menus. Traditionally, these pop-up menus (upon activation) present all possible selection items at once. A menu system employing a cascading technique could progressively display controls of interest in small groups of items over time and thereby reduce visual search times and improve user performance. In some further embodiments, the interface can acquire knowledge of a user's most frequently chosen items and display such items first in a cascading sequence.

Alternatively or additionally, navigational links embedded in dynamic Web pages can be presented in a cascade. Prior art systems present such links in a static fashion, with all links in a sidebar or navigation pane appearing simultaneously. In some embodiments, the interface can be configured to use a cascading technique to first present the most salient or relevant links in a Web page document to users. The cascading technique can be used to present links in a progressive fashion, allowing users to efficiently move from page to page while minimizing search times for embedded links in a page with many such links. Link selection can be based on any variable or combination of variables including, but not limited to, a profile specific to an individual Web page client or the preferences of a Web page author. These techniques may be applied to other documents, such as web logs (“blogs”), HTML formatted communications (e.g. emails), electronic forms, and so forth.

### IV. CASCADING IMAGES OF TEXT WITHIN OR BEHIND CONTROLS

An additional form of cascade can be constructed using individual image files for characters that will compose the text of the control button in a selection grid. Image files can be created using any typical image manipulation program (e.g. Photoshop, MS Paint etc.). These image files can be constructed to present each character in a unique font, color, shape or size. The flexibility allows for an infinite range of possibilities for how the text appears on the screen. When a user initially uses the particular text, it can be displayed in an easily readable format. Afterward, however, the format can be made less readable. The advantage of making this change is that the user's own past experience with that text (i.e., memory) and his current intention for the search combine with the presentation style of the characters on the screen to create a faster search for modified characters than for non-modified characters.

The use of separate image files for each character allows for employing this technology for enhanced security. CAPTCHAs have been routinely used to ensure human presence during computer transactions because computers are notoriously bad at parsing out the characters within images. CAPTCHAs are single image files containing a random sequence of characters, further obfuscated with image distortion of various forms (e.g. colours and lines). CAPTCHAs are often also very user unfriendly since random, hard to read characters are difficult to recognize. The current technology uses a series of individual character images to create non-random sequences or text. The use of individual image files enables a large degree of flexibility in how each character is rendered. It also enables “on-the-fly” programmatic control on many characteristics of the images including size, shape and orientation. This control allows interface designers to include dynamic learning of text rendering to the interface so that as users increase their frequency of selecting certain options, those options can be portrayed in unique ways to capitalize on the perceptual interaction between the user's mind and the interface. These sequences realize the user's expectation, creating a unique salient and immediate recognition experience.

In the security context, on the other hand, the user knows what his selection should be, but the non-user does not. The modified text is difficult for a non-user to read, but easy for the user. This technology then will enhance security in a number of ways. First, OCR technology would not be able to read the text on the screen because of the use of image files. The effectiveness of automatic identity theft would be substantially reduced. Second, the non-user who attempts to shoulder surf, or otherwise follow the user's selection by looking at the user's screen will be impeded by the obfuscation of the characters of the text. Finally, the security can be further enhanced by employing specific behavioral tracking software that treats the speed of responding as a biometric. One such system is described in U.S. Patent Application No. 60/797,718, entitled “System And Method of Enhancing User Authentication Through Estimation of Future Response Patterns,” the content of which is hereby incorporated by reference in its entirety. The user's speed will be much different from a non-user's with the adoption of the individual character image file technology.

### V. EXAMPLE IMPLEMENTATION

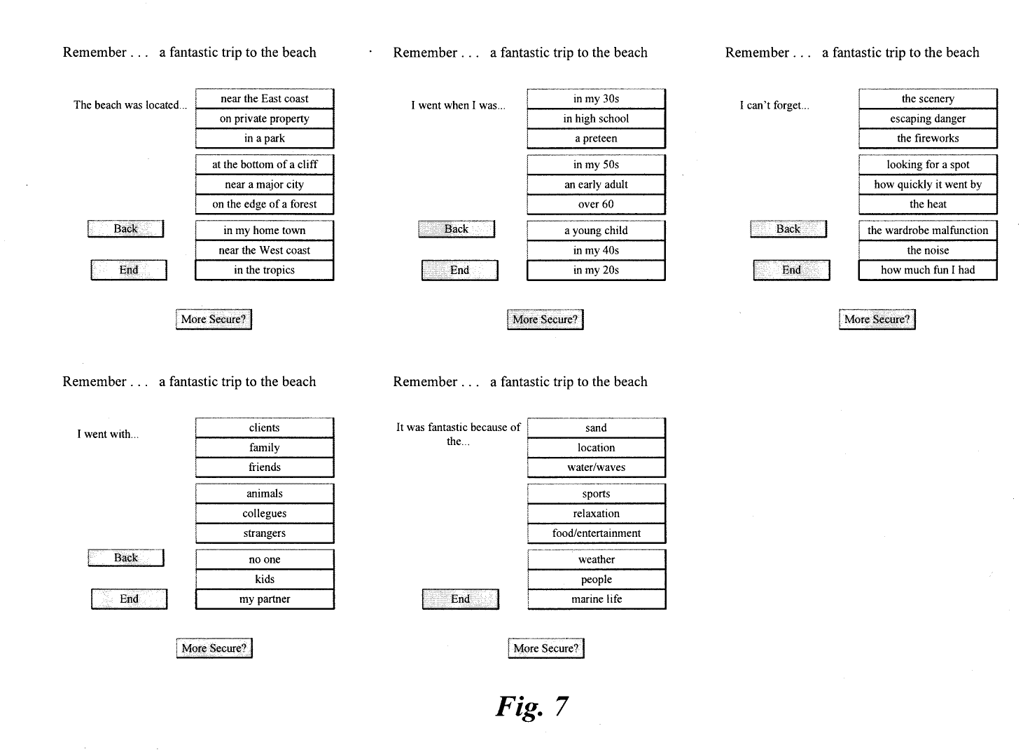

FIGS. 7, 8 and 9 demonstrate one example of a security implementation according to some embodiments. FIG. 7 illustrates the enrolment process of one event. During this stage the user completes a single life event, learns how the process works, and at the same time, becomes accustomed to the cascading options. The nine options for each event cascade in groups of three on a presentation schedule suitable for the individual user. Typically, this schedule would involve longer delays between successive groups of options being presented for new users, or inexperienced computer users, than for seasoned users of the interface, or experienced computer users.

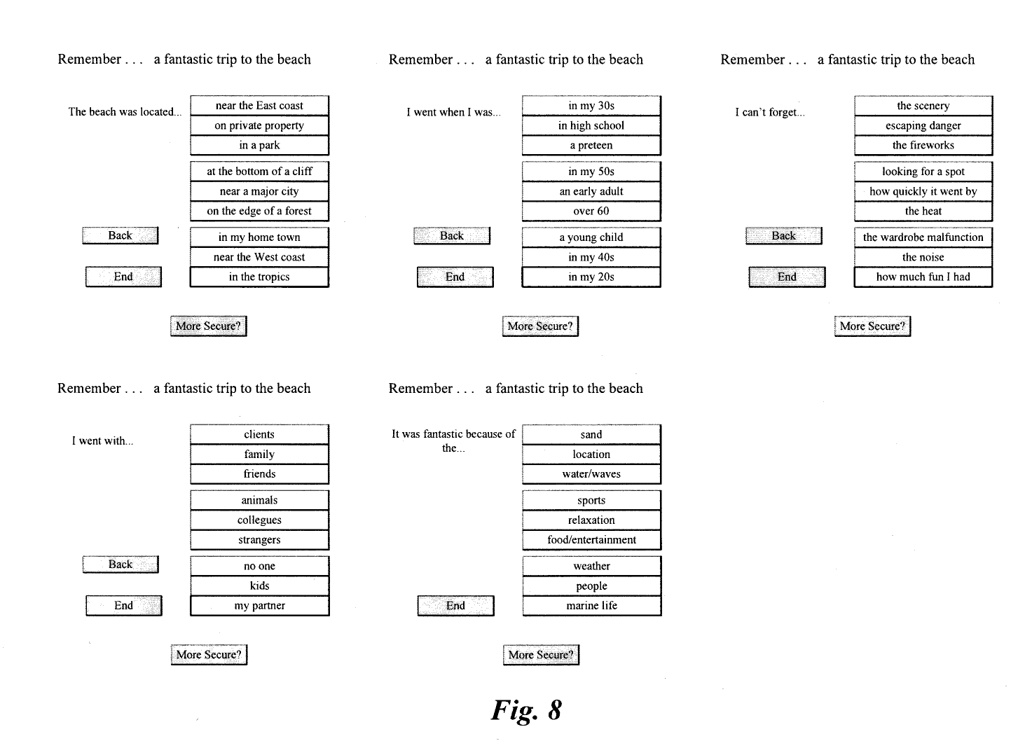

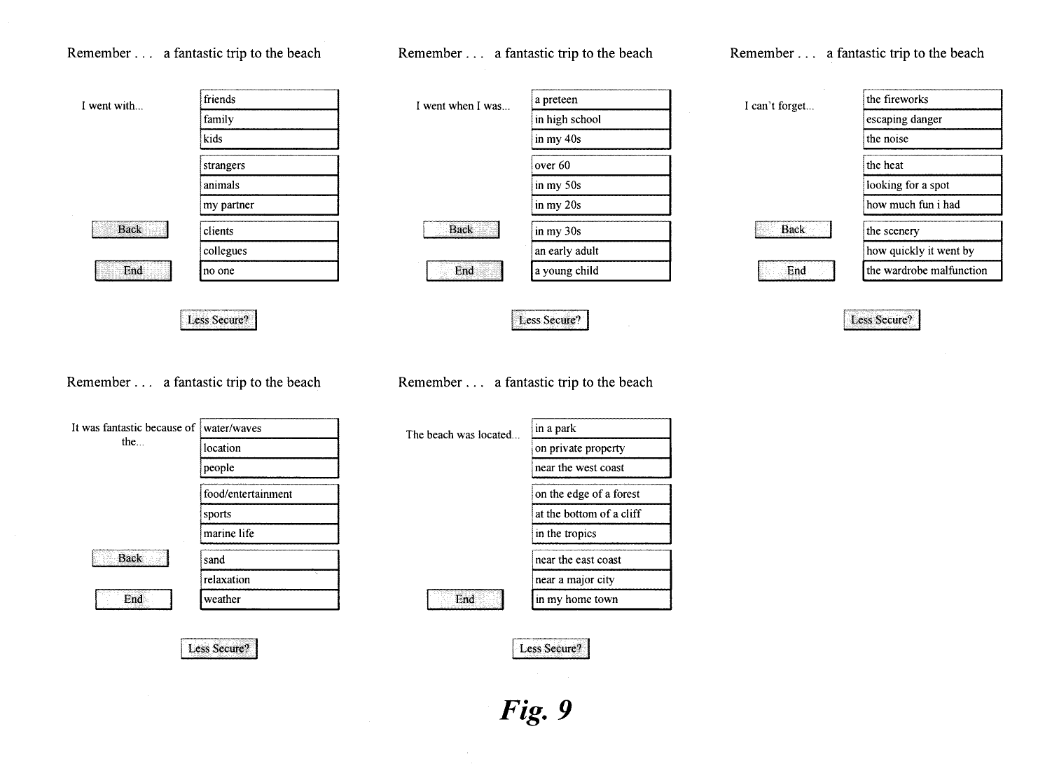

FIG. 8 illustrates the recognition phase that a user may complete during authentication. In some embodiments, the recognition text may look exactly like the enrolment text for the first time the user goes through this process. In subsequent authentications, the text becomes progressively modified as illustrated in FIG. 9.

The examples of FIGS. 7-9 illustrate several modifications to the display process for text information. The mind of the user will capitalize on these modifications by focusing attention and selection toward the easiest choice—that which he desires. Security is enhanced synergistically by combining the systems and methods described herein with the Prom interface technology described in U.S. patent application Ser. No. 11/608,186, filed Dec. 7, 2006, entitled “Authentication System Employing User Memories,” the content of which is hereby incorporated by reference in its entirety, and with the MindsEye Behavioral estimation technology described in U.S. patent application Ser. No. 11/737,692, filed Apr. 19, 2007, entitled “System And Method Of Enhancing User Authentication Through Estimation Of Future Response Patterns,” the content of which is hereby incorporated by reference in its entirety, and the Mousemetric technology described in U.S. application Ser. No. 11/747,729, filed 11 May 2007, entitled “Security Or Authentication System And Method Using Manual Input Measurements, Such As Via User Manipulation Of A Computer Mouse,” the content of which is hereby incorporated by reference in its entirety.

### VI. CONCLUSION

The teachings provided herein can be applied to other systems in addition to the systems described herein. The cascading user interface described above can be implemented in any interface for any type of application now in existence or yet to be created. The elements and acts of the various embodiments described herein can be combined to provide further embodiments.

Any patents, applications and other references, including any that may be listed in accompanying filing papers, are incorporated herein by reference. Aspects of the interface can be modified, if necessary, to employ the systems, functions, and concepts of the various references described above to provide yet further embodiments of the interface.

These and other changes can be made to the interface in light of the above Detailed Description. While the above description details certain embodiments of the interface and describes the best mode contemplated, no matter how detailed the above appears in text, the interface can be practiced in many ways. Details of the interface may vary considerably in its implementation details, while still being encompassed by the disclosure. As noted above, particular terminology used when describing certain features or aspects of the interface should not be taken to imply that the terminology is being redefined herein to be restricted to any specific characteristics, features, or aspects of the interface with which that terminology is associated. Accordingly, the actual scope of the disclosure encompasses not only the disclosed embodiments, but also all equivalent ways of practicing or implementing the interface.

In general, the detailed description of embodiments of the interface is not intended to be exhaustive or to limit the disclosure to the precise form disclosed above. While specific embodiments of, and examples for, the interface are described above for illustrative purposes, various equivalent modifications are possible within the scope of the disclosure, as those skilled in the relevant art will recognize. For example, while processes are presented in a given order, alternative embodiments may perform routines having steps in a different order, and some processes may be deleted, moved, added, subdivided, combined, and/or modified. Each of these processes may be implemented in a variety of different ways. Also, while processes are at times shown as being performed in series, these processes may instead be performed in parallel, or may be performed at different times.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

I claim:

1. A method for displaying a graphical user interface, the method comprising:
displaying a primary user-selectable control in a graphical user interface;
receiving a user selection of the primary displayed control;
displaying a first group of user-selectable controls based on the selected primary control; and
after expiration of a predetermined time, automatically displaying a second group of user-selectable controls based on the selected primary control.

2. The method of claim 1, further comprising displaying the primary control on a toolbar.

3. The method of claim 1, wherein the first group of controls comprises at most three controls.

4. The method of claim 1, further comprising displaying the first and second groups of controls such that the display of the first and second groups is perceptibly separated in time while being perceived by the user as part of a single option list.

5. The method of claim 1, further comprising selecting the predetermined time such that the first group of controls can be completely scanned by a user before the display of the second group of controls.

6. The method of claim 1, further comprising selecting the predetermined time to approximate a natural saccade-fixation cycle of a human eye.

7. The method of claim 1, further comprising determining a frequency at which predetermined controls are selected.

8. The method of claim 7, further comprising:
determining relative frequencies of user selections within a group of controls; and
displaying high frequency selections before low frequency selections.

9. The method of claim 1, further comprising:
detecting whether the user has made a selection of a displayed control from the first group or the second group; and
if the user has made a selection of a displayed control, displaying no further groups of controls.

10. The method of claim 1, wherein the first group of controls further comprises text displayed as multiple images, each of the displayed images comprising a corresponding text character.

11. The method of claim 10, further comprising impairing the clarity and readability of at least one of the displayed text characters.

12. The method of claim 11, wherein the clarity of the displayed text is based on a determined selection frequency of a control.

13. A machine-readable medium having stored thereon instructions which when executed by a processor cause the processor to perform method for displaying a graphical user interface, the method comprising:
displaying a primary user-selectable control in a graphical user interface;
receiving a user selection of the primary displayed control;
displaying a first group of user-selectable controls based on the selected primary control; and
after expiration of a predetermined time, automatically displaying a second group of user-selectable controls based on the selected primary control.

14. The medium of claim 13, the method further comprising displaying the primary control on a toolbar.

15. The medium of claim 13, the method further comprising displaying the first and second groups of controls such that the display of the first and second groups is perceptibly separated in time while being perceived by the user as part of a single option list.

16. The medium of claim 13, the method further comprising selecting the predetermined time to approximate a natural saccade-fixation cycle of a human eye.

17. A system for displaying a graphical user interface, comprising:
a data processor;
a user input device coupled to the data processor; and
a display device coupled to the data processor,
wherein the data processor is further configured to:
display a primary user-selectable control in a graphical user interface on the display;
receive a user selection of the primary displayed control from the user input device;
display a first group of user-selectable controls based on the selected primary control; and
after expiration of a predetermined time, automatically display a second group of user-selectable controls based on the selected primary control.

18. The system of claim 17, wherein the data processor is further configured to display the primary control on a toolbar.

19. The system of claim 17, wherein the data processor is further configured to display the first and second groups of controls such that the display of the first and second groups is perceptibly separated in time while being perceived by the user as part of a single option list.

20. The system of claim 17, wherein the data processor is further configured to select the predetermined time to approximate a natural saccade-fixation cycle of a human eye.
